(19) United States
(12) Patent Application Publication
(10) Pub. No.: US 2014/0022300 A1
(43) Pub. Date: Jan. 23, 2014

(54) STRAY INK COLLECTION APPARATUS FOR PRINTER

(71) Applicant: HON HAI PRECISION INDUSTRY CO., LTD., New Taipei (TW)

(72) Inventors: Wen-Chung LO, New Taipei (TW); Pei-Jung LEE, New Taipei (TW)

(73) Assignee: HON HAI PRECISION INDUSTRY CO., LTD., New Taipei (TW)

(21) Appl. No.: 13/858,719

(22) Filed: Apr. 8, 2013

(30) Foreign Application Priority Data
Jul. 20, 2012 (TW) 101126216

(51) Int. Cl. B41J 2/165

(52) U.S. Cl. CPC B41J 2/16523
USPC 347/25

(57) ABSTRACT

A stray ink collection apparatus includes an air duct facing to a nozzle, a collection box, an absorber received in the collection box, and a pump mechanism. The air duct and the pump mechanism are secured to two opposite sides of the collection box. The pump mechanism is capable of generating a suction force to suck stray ink from the nozzle to the collection box via the air duct, and the absorber is capable of absorbing the stray ink.

### BACKGROUND

1. Technical Field

The present disclosure relates to collection apparatuses, and more particularly to an ink collection apparatus for collecting stray ink in a printer.

2. Description of Related Art

In general, an ink-jet printer includes at least one print head that ejects drops or jets of liquid onto a recording or image forming media. The head has a nozzle to eject the liquid ink. While the nozzles inject the liquid ink on the printing material, some ink may fly loose in the printer and contaminate components of the printer.

Components of the printer may be damaged because of accumulated ink.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of an stray ink collection apparatus.

FIG. 2 is similar to FIG. 1, but viewed from a different aspect.

FIG. 3 is an assembled view of the stray ink collection apparatus.

FIG. 4 is a schematic view of the stray ink collection apparatus.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one”.

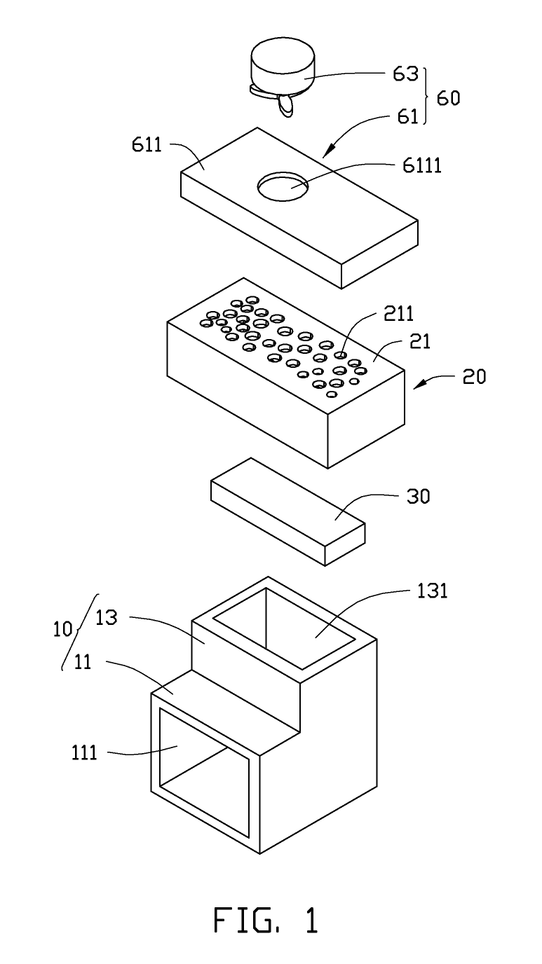

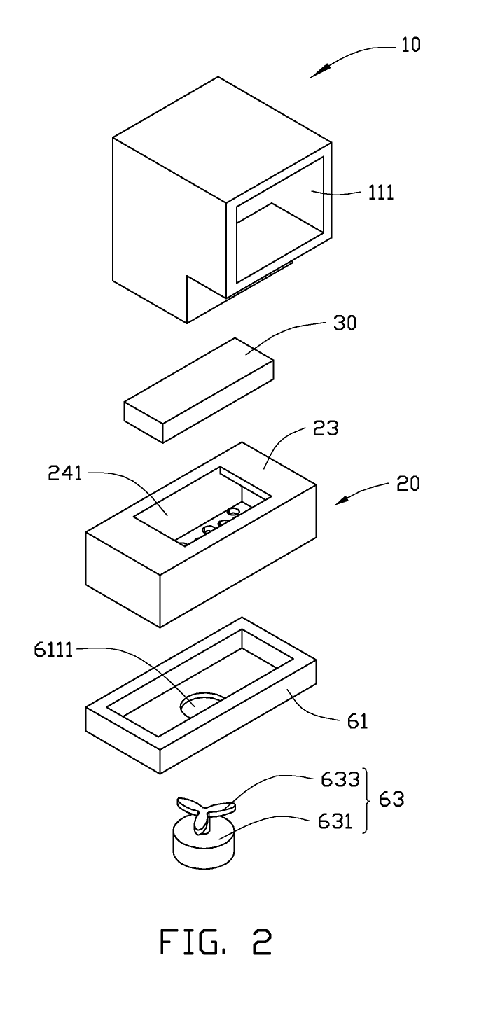

FIGS. 1 and 2 show an stray ink collection apparatus for printers in accordance with an embodiment. The stray ink collection apparatus includes an air duct 10, a collection box 20 attached to the air duct 10, an absorber 30 received in the collection box 20, and a pump mechanism 60.

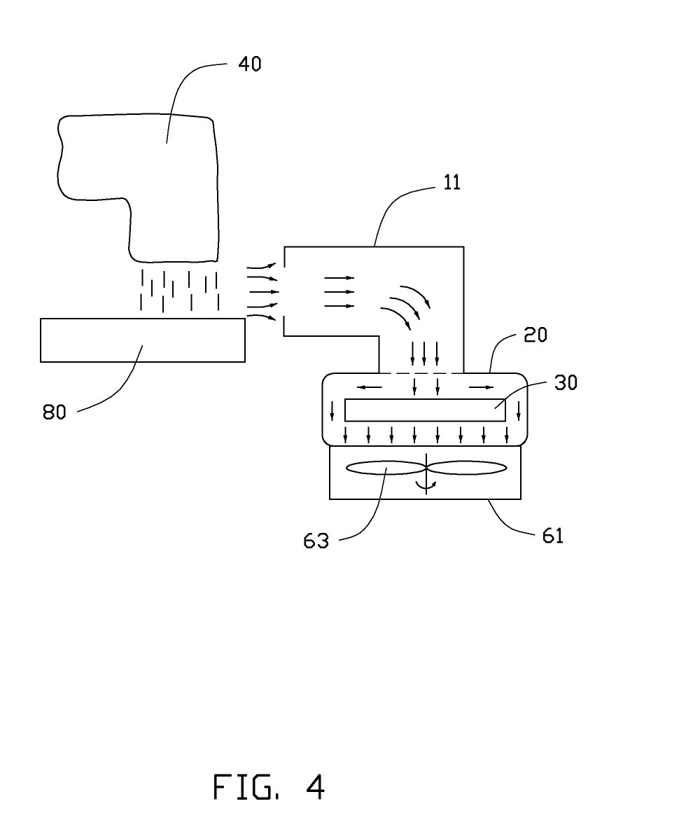

The air duct 10 includes a first pipeline 11 and a second pipeline 13 communicating with the first pipeline 11. The first pipeline 11 defines an entrance 111 facing a nozzle 40 (shown in FIG. 4). The second pipeline 13 defines an outlet 131 communicating with the collection box 20.

The collection box 20, located between the air duct 10 and the pump mechanism 60, defines an opening 241 for stray ink to travel into the collection box 20. The collection box 20 further includes a top wall 21 and a bottom wall 23 opposite to the top wall 21. The top wall 21 defines a plurality of apertures 211. The opening 241 is defined in the bottom wall 23, communicating with the apertures 211.

The absorber 30 is capable of absorbing liquid. In one embodiment, the absorber 30 is a sponge.

The pump mechanism 60 includes an installation member 61 and a pump fan 63. The installation member 61 includes a top portion 611. The top portion 611 defines an installation hole 6111 for receiving the pump fan 63. The pump fan 63 includes a driving portion 631 and a plurality of blades 633 connected to the driving portion 631. The driving portion 631 is capable of rotating the blades 633. The blades 633 extend through the installation hole 6111, and the driving portion 631 is engaged in the installation hole 6111.

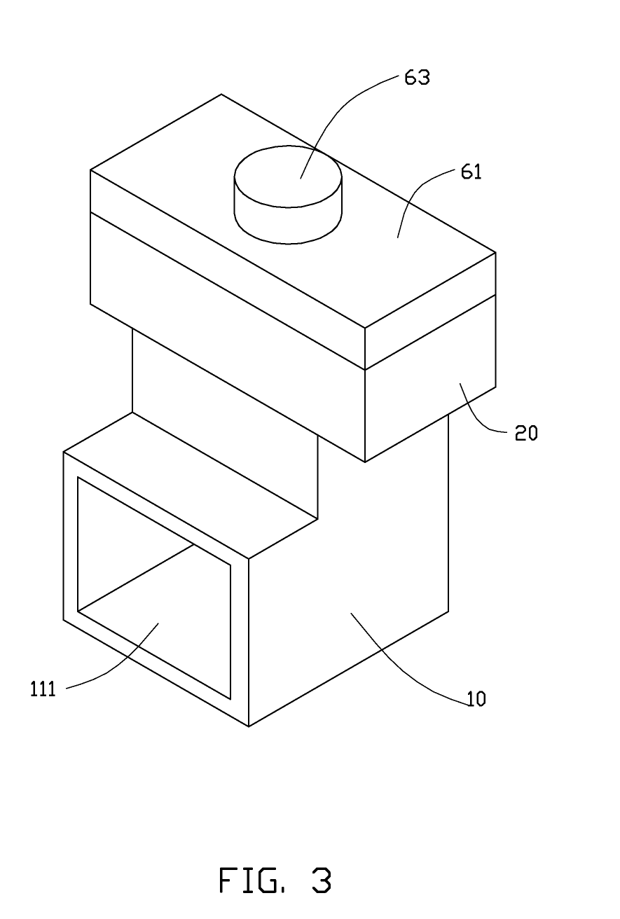

Referring to FIG. 3, in assembly, the absorber 30 is glued to the collection box 20. The pump mechanism 60 is installed on the top wall 21, and the plurality of blades 633 is located between the top wall 21 and the top portion 611. The second pipeline 13 of the air duct 10 is secured to the bottom wall 23 of the collection box 20, and the outlet 131 of the air duct 10 is communicated with the opening 241 of the collection box 20.

Referring to FIG. 4, in use, the stray ink collection apparatus is located on one side of the nozzle 40, and the entrance 111 of the air duct 10 is aligned with the nozzle 40. The pump fan 63 rotates to generate suction force to suck the stray ink via the apertures 211 and the air duct 10, into the collection box 20 to be absorbed by the absorber 30, to collect stray ink spreading out of a stray ink dispersal area 80.

It is to be understood, however, that even though numerous characteristics and advantages of the embodiments have been set forth in the foregoing description, together with details of the structure and functions of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A stray ink collection apparatus for a printer, comprising:
an air duct facing to a nozzle;
a collection box;
an absorber received in the collection box; and
a pump mechanism,
wherein the air duct and the pump mechanism are secured to two opposite sides of the collection box, the pump mechanism is capable of generating a suction force to suck stray ink from the nozzle to the collection box via the air duct, and the absorber is capable of absorbing the stray ink.

2. The stray ink collection apparatus of claim 1, wherein the collection box defines an opening for receiving the stray ink.

3. The stray ink collection apparatus of claim 2, wherein the collection box comprises a top wall and a bottom wall, opposite to the top wall; the air duct is secured to the bottom wall; and the pump mechanism is secured to the bottom wall.

4. The stray ink collection apparatus of claim 3, wherein the opening is defined in the bottom wall, and the top wall defines a plurality of apertures to place the collection box in communication with the pump mechanism.

5. The stray ink collection apparatus of claim 3, wherein the air duct comprises a first pipeline, the first pipeline defines an entrance, the first pipeline is aligned with the nozzle, and the stray ink is absorbed into the air duct through the entrance.

6. The stray ink collection apparatus of claim 5, wherein the air duct further comprises a second pipeline, the second pipeline is connected to the first pipeline and defines an outlet, and the outlet is in communication with the opening of the collection box.

7. The stray ink collection apparatus of claim 4, wherein the pump mechanism comprises an installation member and a pump fan, the installation member is secured to the top wall, and the pump fan is secured to the installation member.

8. The stray ink collection apparatus of claim 7, wherein the installation member defines an installation hole, and the pump fan is engaged in the installation hole.

9. The stray ink collection apparatus of claim 1, wherein the absorber is a sponge.

10. A stray ink collection apparatus for a printer, comprising:
an air duct facing to a nozzle;
a collection box defining an opening and a plurality of apertures in communication with the opening;
an absorber received in the collection box; and
a pump mechanism,
wherein the air duct and the pump mechanism are secured to two opposite sides of the collection box, the air duct is in communication with the collection box through the opening, and the pump mechanism is in communication with the collection box through the plurality of apertures; the pump mechanism is capable of generating a suction force to suck stray ink from the nozzle to the collection box via the air duct, and the absorber is capable of absorbing the stray ink.

11. The stray ink collection apparatus of claim 10, wherein the collection box comprises a top wall and a bottom wall opposite to the top wall; the air duct is secured to the bottom wall; and the pump mechanism is secured to the bottom wall.

12. The stray ink collection apparatus of claim 11, wherein the opening is defined in the bottom wall, and the plurality of apertures are defined in the top wall.

13. The stray ink collection apparatus of claim 10, wherein the air duct comprises a first pipeline, the first pipeline defines an entrance, the first pipeline is aligned with the nozzle, and the stray ink is sucked into the air duct through the entrance.

14. The stray ink collection apparatus of claim 13, wherein the air duct further comprises a second pipeline, the second pipeline is connected to the first pipeline and defines an outlet, and the outlet is in communication with the opening of the collection box.

15. The stray ink collection apparatus of claim 11, wherein the pump mechanism comprises an installation member and a pump fan, the installation member is secured to the top wall, and the pump fan is secured to the installation member.

16. The stray ink collection apparatus of claim 15, wherein the installation member defines an installation hole, and the pump fan is engaged in the installation hole.

17. The stray ink collection apparatus of claim 10, wherein the absorber is a sponge.
